(19) United States
(12) Patent Application Publication
(10) Pub. No.: US 2013/0346201 A1
(43) Pub. Date: Dec. 26, 2013

(54) METHOD FOR IN-STORE COMPETITION WITH INTERNET SALES PRICING

(71) Applicant: Eric P. Bilange, San Diego, CA (US)

(72) Inventor: Eric P. Bilange, San Diego, CA (US)

(73) Assignee: QUALCOMM Labs Incorporated, San Diego, CA (US)

(21) Appl. No.: 13/531,054

(22) Filed: Jun. 22, 2012

(51) Int. Cl. G06Q 30/02

(52) U.S. Cl. CPC G06Q 30/0256
USPC 705/14.54

(57) ABSTRACT

Methods and systems for intercepting Internet product searches conducted by a consumer within a store enable a merchant to initiate in-store actions, such as presenting counteroffers, to compete for the consumer's business and recover sales that otherwise might be lost to online competitors. The merchant system may employ a variety of technologies to monitor Internet product searches conducted by consumers. In response to determine that an Internet product search has been conducted by the consumer, a merchant server may determine whether any in-store action is warranted to compete. If the merchant server concludes that an in-store counteroffer should be generated, the server may generate an in-store display, announcement or sale agent action to present a counteroffer to the consumer.

### BACKGROUND

Modern consumers may use their cell phones to conduct online price comparisons while shopping in brick-and-mortar stores. For example, while shopping in an electronics store looking at television sets, consumers may use their smart phones or tablet computers to access Google, Amazon.com and online retailers to check the best available price for the same television set. This practice places the store in the uncomfortable position of being the physical display for online retailers. Thus, consumers may go to a store to evaluate a product, but then purchase the product online if an online retailer offers a lower price.

### SUMMARY

The various embodiments provide systems and methods for monitoring a consumer's Internet product search and executing in-store actions, such as making counteroffers, based on competitor offers viewed and available to the consumer. Using methods such as WiFi network monitoring and mobile application activity reporting, a merchant server may recognize when consumers execute an Internet product search on their mobile computing devices while within a merchant store. The merchant server may determine the pertinent details of competing offers for products offered for sale by the merchant, and decide whether to compete by evaluating a variety of factors, such as the competitor's offered price, the merchant store's inventory, and previous shopping characteristics of the consumer. If the merchant server decides to compete for the consumer's purchase, the merchant server may generate and transmit competing offer information and/or instructions to be executed by store displays, electronic product displays, or in-store audible announcements.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a network suitable for use with the various embodiments.

FIGS. 2-4 are process flow diagrams illustrating embodiment methods for detecting consumer Internet product searches and providing in-store counteroffers suitable for use with the various embodiments.

FIG. 5 is a process flow diagram illustrating an embodiment method for determining whether a merchant will compete with a detected Internet product search suitable for use with the various embodiments.

FIG. 6 is a process flow diagram illustrating an embodiment method for determining competitor offer information suitable for use with the various embodiments.

FIG. 7 is a process flow diagram illustrating an embodiment method for developing an in-store counteroffer suitable for use with the various embodiments.

FIG. 8 is a component block diagram of an example wireless tablet device suitable for use with the various embodiments.

FIG. 9 is a component block diagram of an example wireless mobile computing device suitable for use with the various embodiments.

FIG. 10 is a component block diagram of an example laptop computing device suitable for use with the various embodiments.

FIG. 11 is a component block diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “mobile computing device” is used herein to refer to any one or all of cellular telephones, smart phones, personal or mobile multi-media players, personal data assistants (PDA's), laptop computers, tablet computers, smart books, palm-top computers, wireless electronic mail receivers, multimedia Internet enabled cellular telephones, and similar personal electronic devices which include a programmable processor and memory and circuitry at least capable of sending and/or receiving wireless and/or wired data transmissions, accessing Internet websites, and performing various calculations.

If, while browsing products within a merchant's store, the consumer uses his/her mobile computing device (e.g., a smart phone or tablet computer capable of interacting with the Internet) to conduct product comparisons online. For example, the consumer may find a television in the merchant's store and use his smart phone to search an Internet competitor's website for the competitor's pricing information for the same product. If the Internet product search reveals that a lower price for a product is available online, the consumer may decide to leave the store without purchasing the product from the merchant.

The various embodiments provide methods and systems for monitoring or intercepting Internet product searches conducted by a consumer while within a merchant's store and initiating in-store actions, such as presenting counteroffers, to compete for the consumer's business. The methods and systems enable the merchant to take actions to recover sales that otherwise might be lost to online or Internet competitors. The merchant may employ any of a number of mechanisms and technologies to monitor Internet product searches conducted by consumers within their store. In response to determine that an Internet product search has been conducted by the consumer while within the store, the merchant server may determine whether any in-store action is warranted to compete. If the server concludes that an in-store counteroffer should be generated, the server may generate or cause another computer to generate an in-store display or audible announcement to deliver the counteroffer to the consumer.

In the various embodiments, the merchant may employ a variety of mechanisms for learning about or intercepting Internet searches by consumers. In an embodiment, the merchant may distribute software (e.g., a “mobile app”) for use on consumer mobile computing devices which may monitor the consumer's activities and report back to a merchant server. For example, consumers may choose to upload a merchant's mobile application in return for coupons, loyalty points, and other consumer loyalty program incentives. Once installed on the consumer's mobile computing device, the merchant's application may execute routines on the processor that monitor Internet communications for online searches for products offered for sale by the merchant. When a search for a product on sale by the merchant is recognized, the merchant's application may cause the consumer's mobile computing device to transmit a message to the merchant's server via the Internet reporting the search details, such as the product searched and price available on line. Since consumers freely elect to upload the merchant's application in return for the merchant incentives, consumers agree to the monitoring and reporting of the consumer searches. The merchant application may also include functionality to determine the location of the consumer-conducted the search and include that information when reporting the recognized search. Such location reporting information may enable the merchant server to determine when the search is being conducted within a merchant's store.

In another embodiment, the merchant server may receive third-party reports of the consumer's Internet product searching. This may be accomplished, for example, if the merchant, or a service to which the merchant subscribes, supports Internet product searches in return for consumer incentives (e.g., coupons, discounts, merchant loyalty points, etc.). The product search server may then report product searches and the consumer identification to the merchant's server to enable it to generate counteroffers.

In another embodiment, the merchant may offer consumers free WiFi access in return for consumer agreement to monitor consumer Internet product searches conducted using the WiFi service. The merchant may then monitor the consumers' use of network communications provided by the store for consumers conducting product searches for merchandise offered for sale while in the store. By monitoring the searches, the merchant server may identify the specific product being searched and the price offered by the online competitor. The merchant server may use URLs describing the consumer's product search to access the same website to discover the competitor's product and/or pricing information. The merchant may also determine the location of the consumer conducting the search within the store by using wireless signal triangulation techniques. Thus, in this embodiment, the merchant server may not know the identity of the consumer, but may determine the area in the store where the consumer is standing.

In response to recognizing that a consumer has conducted an Internet product search for a product sold by the merchant, particularly a search conducted by the consumer while within the store, the merchant server may determine whether any in-store action should be taken to compete for the consumer's purchase. In making this determination the merchant server may investigate and/or evaluate a number of factors, such as the merchant's profit margin on the product, pricing flexibility of the merchant and/or particular store, current store or merchant inventory for the product, total costs to the consumer of purchasing online, the competitor's costs, supply and demand of the particular product, and the consumer's purchase history if available (e.g., via a merchant loyalty program database). The merchant server may also be configured with a set of decision rules to apply to such data in order to arrive at a decision to take in-store actions and to compute a counteroffer to present to the consumer. For example, the merchant server may be configured with a decision algorithm that assigns values to each of the various considerations to arrive at a decision regarding whether the merchant has any ability or incentive to compete. Based on such factors, the merchant server may determine whether the merchant can or should compete to win the consumer's purchase in the store.

If the merchant server determines that the merchant will compete for the consumer's business, the merchant server may generate a competing offer to be presented to the consumer. The merchant server may use information accumulated while deciding whether to compete, such as the competitor's price and inventory levels, to create the competing offer for the searched product. The counteroffer may be in the form of a lowered price or discount on the current price. The competing offer may be a matched or lower price, a combined purchase offer (e.g., 2-for-1), or a free item with the purchase of the product at the store's price, to name just a few examples. Also, the counteroffer may include time restrictions to prompt an immediate purchase and limit the number of units that will be sold at the offered price. Also, the counteroffer may involve similar, but different products than the searched-for product.

The merchant server may also determine the in-store actions that will be taken to present the counteroffer to the consumer. To be most effective, store assets (or store display assets) may be used to promptly present the counteroffer to the consumer soon after the Internet product search is detected. Various store assets, including store displays, overhead speakers, sales agents (or a sales agent's computing device), etc., may be used to present the counteroffer to the consumer. The merchant server may use the consumer's location within the store to develop the location and manner of approaching the consumer. For example, the merchant server may determine that a competing offer should be presented by a sales agent who works in the department in which the consumer is located, and provide the offer and the location (and possibly the name) of the consumer to be approached to a portable computing device held by the sales agent (e.g., a tablet computer). As another example, the merchant server may generate an advertisement video promoting similar products that may be played on store displays along the consumer's projected path through the store. As another example, the merchant server may change the posted price for the product if the product price displays are electronic displays. The merchant server may transmit counteroffer instructions to relevant computing devices within the store to achieve the counteroffer delivery mechanisms selected by the server.

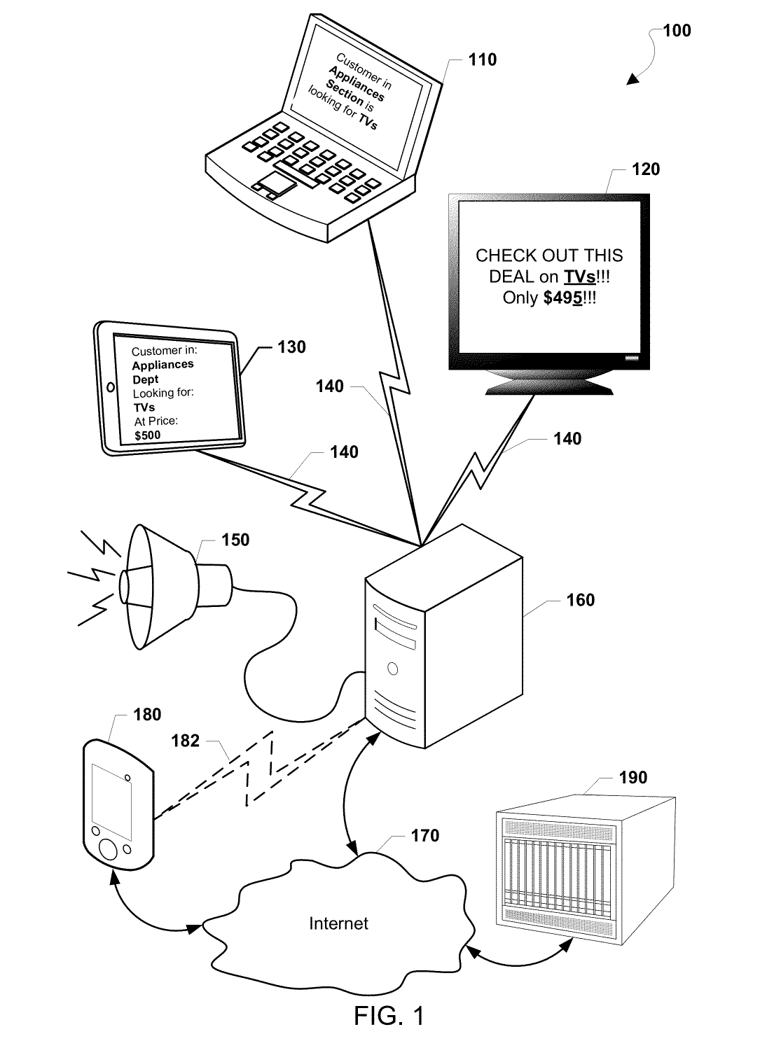

FIG. 1 illustrates a communication system 100 suitable for use with the various embodiments. The system may include a mobile computing device (e.g., a smart phone) 180 that may include a cellular network wireless modem chip that enables communication via a cellular network. The mobile computing device 180 may also contain a global positioning system (GPS) receiver chip, which may determine the location coordinates of the mobile device based on received satellite signals. Through the cellular network connection, the mobile computing device 180 may access the Internet 170 through a variety of wireless networks, such as a local area wireless network 182 (e.g., a WiFi connection) provided by the merchant and connected to a store computing device 160. The store computing device 160 may provide Internet access for the mobile computing device 180 and exchange data with a merchant server 190 that may maintain a database of information relevant to the merchant. For example, the merchant server 190 may maintain a database of previously offered promotions, current inventory for particular products in a geographic region, consumer purchasing trends, particular consumer purchase history, etc.

The store computing device 160 may exchange wireless transmissions 140 (e.g., WiFi, Bluetooth®, Zigbee®, RF radio) with other store devices equipped with wireless transceivers, such as a store laptop computing device 110, a store tablet computing device 130 (e.g., a Samsung Galaxy or Apple iPad), and store display devices (or units) 120 (e.g., a monitor, projector, screen, laptop display, television, etc.). In another embodiment, the various store devices 110, 120, 130 may exchange short-range radio transmissions amongst themselves via their respective transceivers and may each relay data to the store computing device 160. In another embodiment, the system may also contain strategically-placed short-range radio transceiver devices throughout the store at numerous defined positions which may detect the various store devices 110, 120, 130 as they come within a certain radio signal reception proximity. Such strategically placed wireless transceivers may provide information that enables the store computing devices to determine the location of a mobile computing device 180 within the store via trilateration.

The store display devices (or units) 120 may present graphical display information delivered by the store computing device 160, such as text, graphical, or video information, that describes promotional and price information regarding products within the store. Such store displays 120 may be in the form of large display screens on which special promotional items may be presented. Also, store displays 120 may be individual electronic displays that may be positioned on store shelves for presenting the unit prices of merchandise, instead of paper labels that historically have been used in stores. As the cost of electronic displays decreases, the use of such displays in stores may become more common, and may be used with the various embodiments to achieve instant markdown pricing in order to compete for particular consumers' business. In an embodiment, the store computing device 160 or the merchant server 190 may send transmissions 140 to the store displays 120 to cause the store displays 120 to display promotional information, such as counteroffers to consumers conducting in-store online price comparisons.

The store computing device 160 or the merchant server 190 may also be connected to an in-store speaker system 150 which may emit audible promotional announcements within the store. For example, the store computing device 160 may access one or more audio files (e.g., play a .wav file via a media player application) or use a speech synthesizer to create an audible promotional message, and transmit the audio output to the in-store speaker system 150 for amplified performance within the store. Such audible promotional messages may be pre-recorded and/or synthesized speech generated by the store computing device 160 or the merchant server 190. The store computing device 160 or the merchant server 190 may employ the store speaker system 150 to deliver audible promotions to consumers and/or provide directions to in-store sales agents. Sales agents may also make announcements through the store speaker system 150 by speaking into a microphone. In an embodiment, the store speaker system 150 may include a plurality of speakers, and the system may be configured to direct promotional announcements to particular speakers so that the announcements may be heard in the vicinity of the product being searched, thereby being directed to the consumer who conducted the product search.

In an embodiment, laptop computing devices 110 and/or tablet computing devices 130 may be used by sales agents located in particular departments or sections within the store, and carried by sales agents as they move about the store. The store tablet device 130 may be used by sales agents conducting sales in a particular department or arbitrary sections of the store.

In an embodiment, the store computing device 160 or the merchant server 190 may transmit counteroffers, promotional, advertising and/or other information about particular consumers within the store to the store displays 120 and various store computing devices 110, 130. The store computing device 160 may be controlled by a store manager and may be used to exchange sales information with the merchant server 190. In an embodiment, the store computing device 160 may also receive update information from the various store devices 110, 120, 130 such as status indicators from sales agents on the floor. In another embodiment, the store computing device 160 may relay data from the remote merchant server 190 to the various store devices 110, 120, 130. In an embodiment, the various store computing devices 110, 130 may communicate with the merchant server 190 directly, providing the merchant server 190 with information regarding the sales agents operating the various store computing devices 110, 130 and/or information about particular consumer interactions. For example, the store computing device 160 or the merchant server 190 may push promotional coupons or special pricing offers to mobile store computing devices 110, 132 that enable sales agents intended for a particular consumer, enabling the sales staff to personally deliver the promotional offer to the consumer. As another example, a sales agent operating a store tablet device 130 may provide inputs to the device indicating whether a particular consumer was receptive to a counteroffer or contact from the sales agent.

In an embodiment, the system 100 may employ transmission scheduling methods to minimize wireless transmission collisions amongst the store computing device 160 and the various store devices 110, 120, 130. If the numerous store devices 110, 120, 130 transmit data simultaneously, the resulting interference may cause incomplete or corrupted information due to radio signals arriving at the store computing device 160 simultaneously. A system's 100 transmission scheduling methods may involve assigning particular times (e.g., a time within each minute) when particular store devices 110, 120, 130 may transmit data to the store computing device 160. For example, the store tablet device 130 may be assigned a certain range of seconds within each hour to transmit location and/or sales-related data to the store computing device 160, during which all other store devices 110, 120 may not transmit to the store computing device 160.

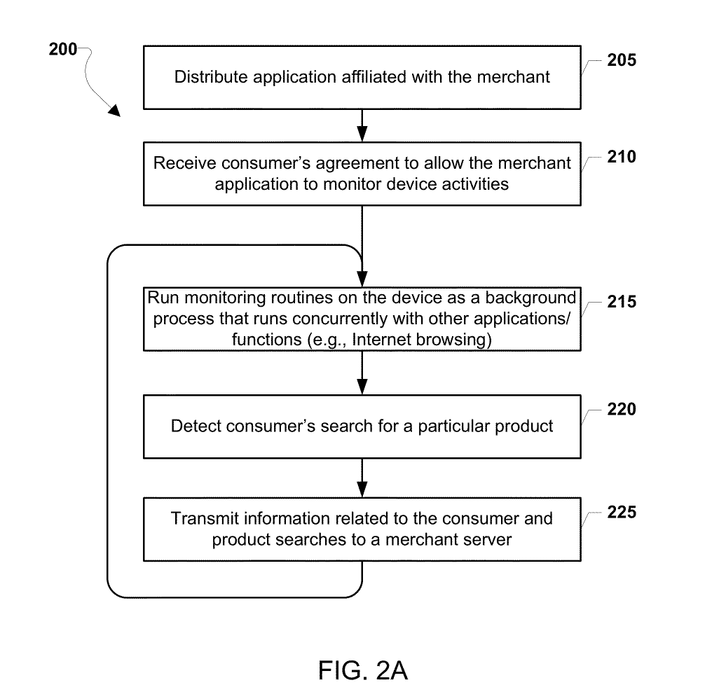

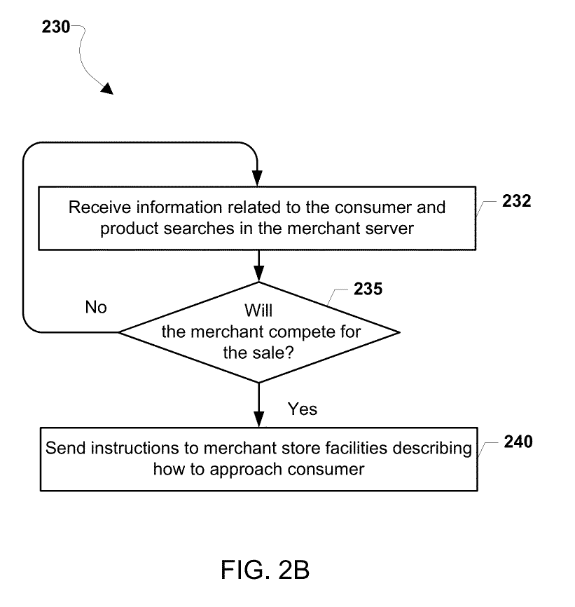

FIGS. 2-4 illustrate methods by which a merchant may monitor consumer Internet product searching and generate an in-store action to compete with Internet product offers. To compete with online offers, the merchant may need to know that the consumer has conducted an Internet search while located within a store, as well as information about the particular searched-for product. FIGS. 2-4 illustrate embodiment methods by which the merchant server may acquire a report of the consumer's Internet product search. With the report, the merchant server may investigate competitors' offers and determine whether and how the merchant may attempt to compete for the consumer's business.

FIG. 2A illustrates an embodiment method by which a merchant learned about consumer Internet product searches using a merchant mobile software application that is located on the mobile devices of consenting consumers. In block 205, the merchant may distribute the mobile software application to a consumer. The merchant may develop the application for use on popular mobile platforms, such as Apple products (e.g., iPad, iPhone, iTouch, etc), Windows phones, Android phones, etc., and offer the application through various online application stores. The merchant application may bear the trademarks and aesthetics of the merchant, such as the merchant's trade dress and color schemes, and may enable consumers to interact with an interface to browse the merchant's offered product lines, research product reviews of the merchant's products, and utilize online services, such as ordering products for delivery. The merchant application may also offer consumer loyalty programs, online coupons, and other financial incentives for uploading the application and continuing to use it over time. In another embodiment, the merchant application may not be visible or otherwise interfaced by the consumer. For example, the merchant application may be software that initializes and operates independently of input on the mobile computing device by the consumer.

In an embodiment, the consumer may obtain the merchant application by downloading the software from an online source, such as the merchant's website or a general software depot or “app store.” For example, using a mobile computing device running Internet browser software, the consumer may connect to the merchant's website, where he may download the merchant application software directly to the device storage of his mobile computing device. The mobile computing device's file management system (i.e., operating system) may enable the consumer to unpack, install, and generally make the merchant application accessible for execution and use by the consumer on the mobile computing device. In an embodiment, the merchant or other source for the application may incentivize the consumer to download the merchant application by associating the download with offers for coupons and other consumer perks. As part of installing the merchant application, the consumer may be required to read and accept the conditions of use, which may include authorization to collect information regarding the consumer's Internet product searches.

The merchant application may utilize the device resources upon which it is downloaded and installed. For example, the merchant application may acquire the consumer's device location from GPS or geo-position software running on the device. To gain access to mobile computing device resources, the merchant application may generate a prompt on a display of the computing device requesting the consumer to grant the necessary permission in block 210. In an embodiment, the merchant application may prompt the consumer at the time of installation to accept a terms of use agreement prior to installing and/or using the application. In an alternative embodiment, the consumer may be prompted to provide permission for the application to use resources of the consumer's mobile computing device when the software is downloaded. In another embodiment, the merchant application may request the consumer to provide permission for the application to use particular resources on the mobile computing device. For example, at installation, the merchant application may display a dialog box on the mobile computing device's display unit which asks the consumer to indicate (e.g., by checking a box) the consumer's permission for the application to access the internal memory of the mobile computing device. As another example, the merchant application may request permission to use the cellular network capabilities of the mobile computing device without consumer approval or interaction. As a further example, the application may request permission from the consumer to track, store, and/or transmit data regarding the consumer's device, the consumer's personal information, and statistics pertaining to telephonic conversations, Internet browsing patterns, and the identity of other installed applications on the device.

In block 215, the merchant application may begin acquiring information about the consumer by running background monitoring routines on the processor of the mobile computing device. In an embodiment, the background monitoring routines may operate regardless of the consumer's interaction with the merchant application. In another embodiment, the merchant application may execute upon the mobile computing device's booting-up the operating system for normal use. For example, the merchant application may be initialized by the mobile computing device's operating system as a start-up program. The background monitoring routines may observe activity and resource use of the mobile computing device for which the consumer provided permission. For example, the background monitoring application routines may recognize when telephonic calls are received on the mobile computing device, identify the applications executed by the consumer and the duration of use for each, and review information stored in the mobile computing device's cache or other memory storage elements. In an embodiment, the background monitoring routines may analyze data transmissions sent from the mobile computing device, including requests for data from Internet servers. The merchant application may record (or log) mobile computing device activity. For example, the application running on the mobile computing device processer may store the time, date, recipient, and other particular details of outgoing Internet protocol communications.

In block 220, the merchant application running on the consumer's mobile computing device may detect consumer Internet product searches. The background monitoring routines of the merchant application may detect consumer inputs on the mobile computing device and/or when the consumer transmits requests and/or received responses from Internet servers providing website data (e.g., HTML information). The background monitoring routines may analyze such Internet protocol transmissions to discern the identity of the Internet sources contacted by the consumer, as well as particular details about the exchanges. The background monitoring routines may parse received and/or requested URL address information to determine domain identities of the providing site. Based on the intercepted and analyzed Internet transmissions of the mobile computing device, the merchant application may determine whether the consumer's activity relates to Internet product searching.

Periodically or upon detecting that a product search has been accomplished, the merchant application running on the consumer's computing device may generate and transmit a product search report message to the merchant server reporting details of the search and the consumer in block 225. The product search report message may include data about the intercepted Internet product search by the consumer, including information such as the product category (e.g., a tool, a toy, cosmetics, etc), the product name, and the UPC code of the product. The product search result message may also include data about the consumer, such as the consumer's demographic characteristics (e.g., age, gender, etc.) and the current location of the mobile computing device. The merchant application may acquire the location information by accessing information from a GPS service running on the mobile computing device or by analyzing network activity logs stored within the mobile computing device. The product search report message may be transmitted via the Internet, e-mail or other electronic message technologies, including via a store's WiFi service. Once the product search result message has been transmitted, the merchant application may continue to run monitoring routines on the consumer's computing device, returning to block 215.

In an embodiment, the report transmission may identify the mobile computing device software with which the consumer requested or received the product search information. For example, the report may indicate that the consumer searched for the product using a mobile application distributed by another merchant. As another example, the report may indicate that the consumer searched for the product using the mobile computing device's Internet browser. Alternatively, the report transmission may simply be an indicator of the consumer identity and a URL describing a product webpage. In another embodiment, the report transmission may include specific information about the searched-for product, such as competitor identities associated with the search results, product prices returned, and search parameters used by the consumer, such as price range and product qualities (e.g., color, dimensions, etc.).

In an embodiment, the merchant application may periodically transmit location data to the merchant server. For example, while the consumer's mobile computing device has an active data link (e.g., cellular network, local area WiFi network, etc.), the merchant application may send messages to the merchant server that describe the current GPS coordinates of the consumer's mobile computing device. Such transmissions of location information may be independent of detected consumer product searches and may be recorded/logged by the merchant server for later use when the merchant server does receive report transmissions regarding intercepted consumer product search data.

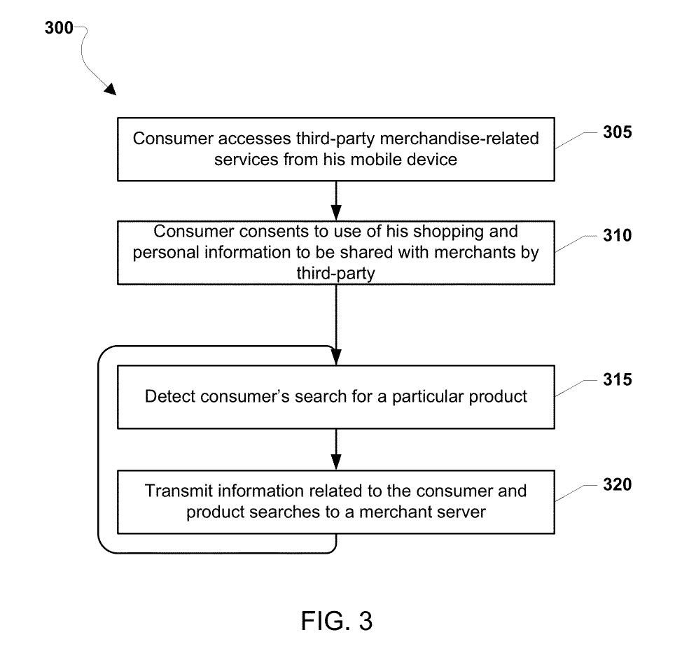

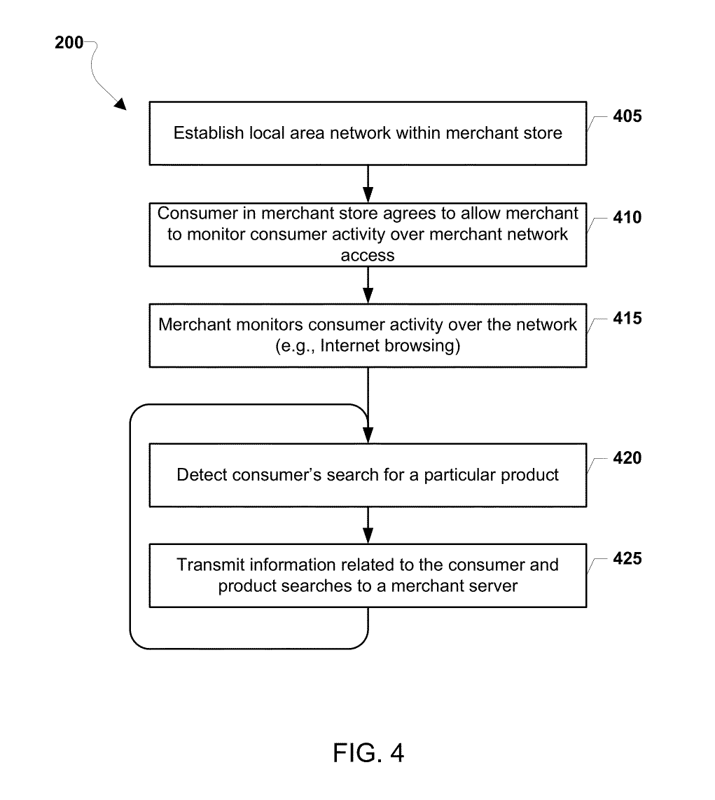

FIG. 2B illustrates an embodiment method 234 utilizing information received regarding consumer product searches to compete with online competitors. In block 232, a merchant server may receive the product search result message describing the intercepted consumer product search. In various embodiments, the product search result message may have been sent by a merchant application running on the mobile computing device as described above. Alternatively or in addition, the product search result message may have been sent by a third-party website/service, or a store computing device acting as an Internet proxy as described in more detail below with reference to FIGS. 3 and 4. It is also possible that the merchant server may receive more than one product search result message for a particular consumer search, such as when the consumer uses a mobile device configured with the merchant application described above to perform a search within the merchant's store using the store's WiFi service.

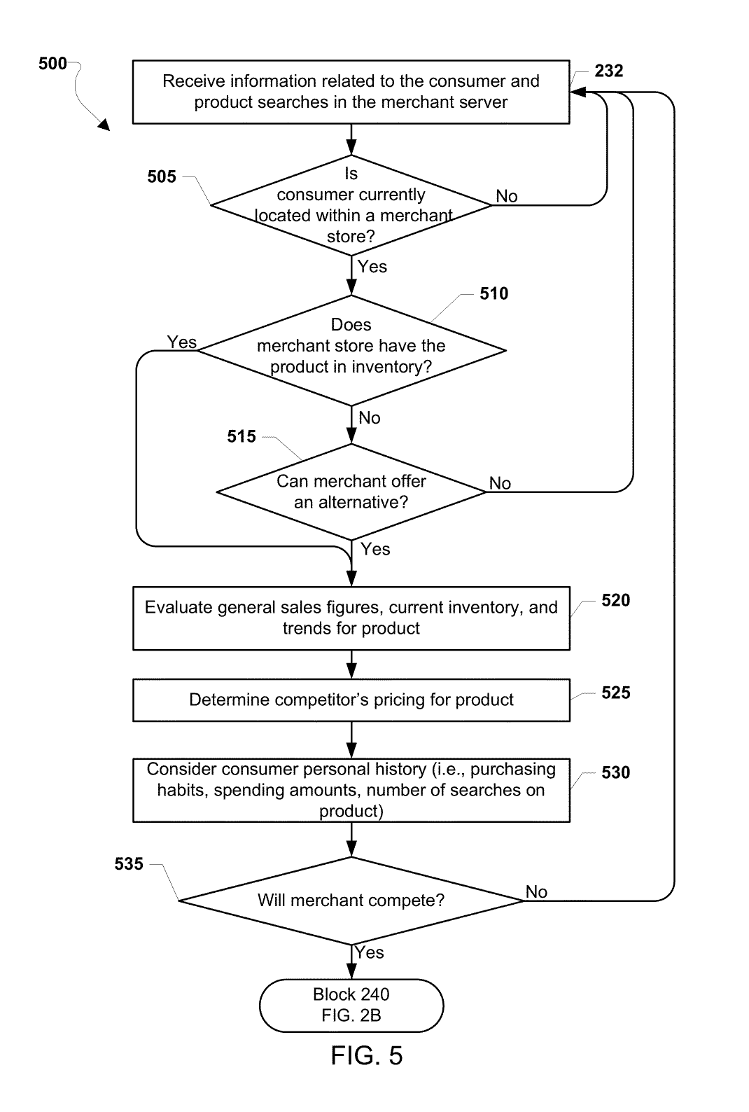

In determination block 235, the merchant server may analyze the received product search result message to determine whether the merchant may act to compete with in-store counteroffers. If the merchant server determines that the consumer's mobile computing device is located within one of the merchant's stores, the merchant server may determine whether the merchant will promote any counteroffer actions to compete with the reported Internet product search. The merchant server may evaluate numerous variables to determine whether it can or should propose a competing offer to the consumer located within its store. In an embodiment, the merchant server may consider competitor overhead costs, convenience to the consumer, merchant inventory, and previous interactions between the merchant and the particular consumer. Operations that may be performed by the merchant server's to determine whether to present the consumer with a counteroffer action are described below with reference to FIG. 5. If the merchant server decides to not proceed with a counteroffer action (i.e., determination block 235=“No”), the system may continue to receive product search result message in block 232.

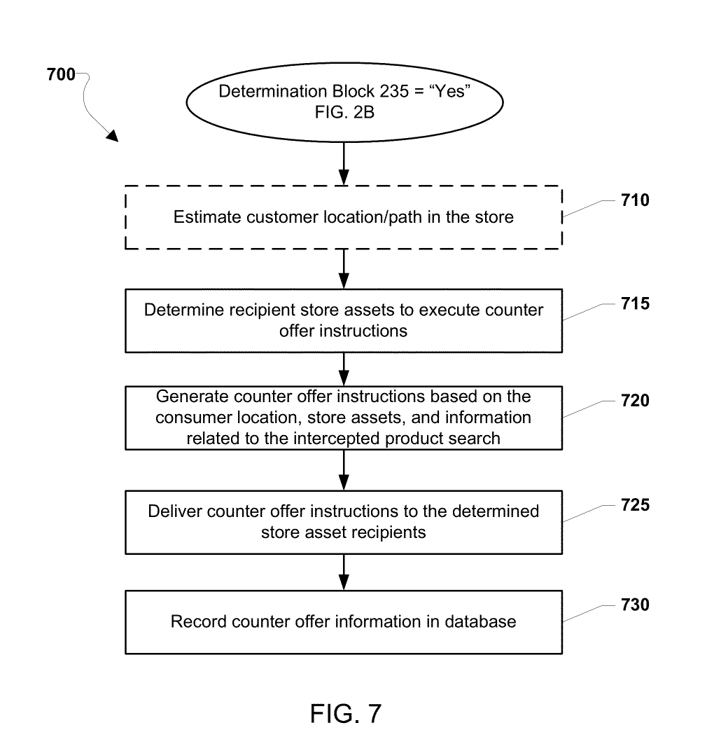

If the merchant server determines that a conduct counteroffer should be presented to the consumer to compete with the intercepted Internet product search (i.e., determination block 235=“Yes”), the merchant server may create instructions for the store facilities that include the counteroffer and how to present the counteroffer consumer in block 240. For example, the merchant server may determine that the store may offer the consumer a discount price on a product similar to the one the item for which the consumer searched. The merchant server may transmit counteroffer instructions to the store's computer, or directly to displays and/or computing devices within the store. In an embodiment, the counteroffer instructions may dictate actions for the sales agents to perform (e.g., approach the consumer in aisle five with the following special offer), generate advertisements or price promotions to be displayed in the store on store displays, or announcements to be made over the store's speaker system. Further details regarding generating counteroffer instructions are described below with reference to FIG. 7.

In some embodiments, the merchant server may be informed of a consumer's online product searches while the consumer is not within a merchant's store. In such situations, the merchant server may note the product search and make a determination regarding presenting a competing offer, however efforts to present the counteroffer to the consumer may wait until the consumer enters one of the merchant's stores. The merchant server may be informed of a consumer entering one of the merchant's stores by the consumer's mobile device through a variety of mechanisms. For example, a merchant application may monitor location information provided by a GPS receiver within the mobile device, and send a report to the merchant server when the location corresponds to a store address. As another example, a store Wi-Fi router may recognize when the consumer's mobile device logs on to the router, and report that fact to the merchant server. As a further example, the merchant server may be informed of a customer's presence in a store based upon transaction information received from a point-of-sale, such as a credit card or loyalty card transaction. Upon learning that the consumer is within one of the merchant's stores, the merchant server may proceed to block 240 to present the competing offer to the consumer as described above.

FIG. 3 illustrates an embodiment method by which a merchant server may be informed of an Internet search by a consumer from a third-party source. In this embodiment, the merchant may contract with a third-party that provides the merchant with information regarding consumer interactions with the third-party's services (e.g., a website supporting multiple product searches). For example, the third-party service may offer a buying service to consumers providing a portal through which they may search for many different types of products available for purchase online. In addition to selling products to consumers, the third-party service report to subscribing merchant servers may provide the merchant with details regarding consumer product searches and consumer demographics based on the products searches conducted by consumers using the third-party website. The third-party service may include a search engine for searching products online, a consumer resource site that provides reviews and product information, such as CNET, a community sales site, such as eBay®, and/or an aggregator website that combines product information from numerous merchants.

In block 305, the consumer may use a computing device to access the third-party service to conduct a product search. For example, the consumer may employ a browser application on a mobile computing device to communicate with the third-party service using Internet protocols and website data (e.g., forms). The consumer may communicate with the third-party service via an application distributed by the third-party, similar to the merchant application described above. In block 310, the consumer may provide consent for the third-party service to use personal and search information gathered during interactions for other commercial purposes, including reporting searches and consumer information to the merchant server. As part of block 305, the third-party service may request location information from the consumer's mobile computing device. For example, upon logging into the third-party website, the user may be prompted with a dialogue display that asks for permission to access the computing device's location information while the consumer accesses the website. Alternatively, the third-party service may determine the location of the consumer mobile computing device by tracing IP routing data derived from the various transmissions exchanged with the consumer mobile computing device.

In block 315, the third-party server may detect when the consumer is attempting to obtain a price for a product, particularly a product sold by the subscribing merchant. Thus, the screening of the product search for a match to the merchant's product line may be accomplished by the third-party server, such as by comparing the product being searched to a product listing provided by the merchant is part of the service subscription process. When the third-party server detects that a consumer is searching for a product on the merchant's product list, the server may gather information regarding the consumer's search, regarding the specific product being searched, and price and quantity information presented to the consumer, as well as consumer information. In block 320, the third-party server may then transmit the gathered product search and consumer information to the subscribing merchant server, such as via Internet communications. The merchant server may receive such reports and process them as described above with reference to FIG. 2B.

FIG. 4 illustrates an embodiment method by which a merchant server may be informed of an Internet search by a store-provided local area wireless network access service (e.g., a free Wi-Fi service). In block 405, the merchant may provide consumers with free Internet access via a WiFi local area network encompassing its store. In an embodiment, the store may have wireless routers positioned around the building that enable the consumer's mobile computing device to connect to the local network and exchange data to the Internet. The consumer's mobile computing device may connect to the store WiFi network using a conventional Wi-Fi transceiver. In block 410, the merchant may control consumer access to the Internet through the provided WiFi network by establishing a permission gate. As is typical in many free Wi-Fi services, the merchant may require the consumer to accept a usage agreement in return for access to the Internet. For example, immediately upon connecting to the merchant's WiFi network, the consumer may encounter a merchant webpage that prompts the consumer to click a graphical user interface button (e.g., HTML button) indicating agreement with the merchant's usage policy. The merchant's usage policy may stipulate that the consumer consents to the merchant monitoring any Internet transmissions exchanged by the consumer. If the consumer accepts the user agreement, the consumer may be granted access to the Internet via the merchant's WiFi network.

In block 415, the merchant's computing device may employ a proxy computing device, such as the store computing device 160 described above with reference to FIG. 1, to route data exchanges between the consumer mobile computing device and the Internet, while monitoring the exchanged data. The proxy computing device may monitor and analyze any data exchanged by the consumer's mobile computing device over the merchant WiFi network in order to detect product searches. In an embodiment, the proxy computing device may parse all data to determine destinations (e.g., URL addresses), data content details (e.g., product search descriptions and/or characteristics), as well as consumer personal information.

In block 420, the store computing device may detect when the consumer is attempting to obtain a price for a product, particularly a product sold by the merchant. This may be accomplished by comparing the product being searched to a product listing maintained in the store computing device or the merchant server. When the store computing device detects that a consumer is searching for a product sold by the merchant, the store computing device may gather information regarding the consumer's search, including the specific product being searched, and price and quantity information presented to the consumer. If the store's Wi-Fi service requires the user to register for service, the store computing device may also be able to obtain consumer information from a database of registered Wi-Fi users maintained by the store computing device or the merchant server. In block 425, the store computing device may then transmit the gathered product search and consumer information to the merchant server, such as via Internet communications. The merchant server may receive such reports and process them as described above with reference to FIG. 2B.

In an embodiment, the merchant server may also receive information from the store computing device that describes the location of the consumer based on WiFi communications within the store. For example, the store computing device may relay to the merchant server that the consumer has accessed a particular WiFi router within the store, thereby providing a rough location within the store of the consumer. In another embodiment, the store computing device may employ triangulation techniques to determine the location of the consumer's mobile device based upon signals received by multiple Wi-Fi routers positioned about the store.

FIG. 5 illustrates an embodiment method 500 for determining whether a merchant will compete with intercepted consumer Internet product searching. The operations of this method may be executed by a merchant server in response to receiving a report transmission regarding an intercepted consumer product search in block 232.

In determination block 505, the merchant server may determine whether the consumer is located within a merchant store when the intercepted Internet product search is being conducted by comparing the location of the consumer's computing device to the store's location. In an embodiment, the merchant server may evaluate data provided in the received report transmission to determine the consumer's computing device location. For example, the merchant server may parse the received product search report message to determine whether it includes GPS coordinates of the consumer's computing device at the time of the intercepted Internet product search. If the product search report was received via an in-store Wi-Fi service, the store computing device supporting that service may be able to report the consumer's location based on the connected router or triangulation among a plurality of routers as discussed above.

In an embodiment, the merchant server may estimate the location of the consumer's mobile device based on ultrasounds emitted by the consumer's mobile device. For example, a merchant store may deploy sound beacons throughout the building that detect ultrasounds information, which may be transmitted to the merchant server for use in triangulating the consumer's location within the store.

In another embodiment, the consumer's location may be provided by a wireless device handed out to consumer to wear while in the store. Such a wireless device may include a GPS unit and a transceiver capable of transmitting GPS coordinates to the merchant server (via the store's local area network), an ultrasound detector configured to triangulate location based on ultrasounds signals received from ultrasound transmitters in fixed locations throughout the store, or a short range radio transceiver configured to estimate distances to a number of extra radio transceivers or beacons positioned around the store. For example, as the consumer enters the store, a merchant sales agent may hand the consumer a small device with which the consumers may interact (e.g., press a “Help” button) to obtain support from the sales agent, but which also periodically reports the location of the consumer within the store to a merchant or store computing device. The merchant server may use the consumer's location determined by these various techniques in combination with the intercepted Internet product searches to be able to present counteroffers to the consumer conducting the searches.

In another embodiment, store wireless devices may determine location and identification (e.g., the mobile computing device's MAC address) information of the consumer's mobile device based on short-range radio signal exchanges. Store wireless devices may use triangulation techniques with exchanged short-range radio signals to estimate the location of the consumer's mobile computing device as well as other devices containing transceivers. As an illustrative example, the store may have an aisle of television units that each include Bluetooth® transceivers that periodically transmit Bluetooth® pairing announcement signals. The consumer's mobile computing device may receive and respond to such signals as it moves down the aisle. The store wireless devices may relay the location information obtained from such message changes to the merchant server for recordation and use with intercepted Internet product searches by the consumer.

As part of the operations of determination block 505, the merchant server may compare the location information of the consumer's mobile computing device to a database of merchant store location information. The database of store location information may include GPS coordinates for each store, along with the dimensions of each individual store. For example, for the particular merchant store, the database may contain the coordinates of the store's center point along with the general length, width, and height of the building. In another embodiment, the database may contain general location information of each store in addition to detailed schematics (i.e., blueprint representations) of each store's floor plan. For example, the database may contain the dimensions of the perimeter walls of each store.

If the merchant server determines that the consumer's mobile computing device is not within a store (i.e., determination block 505=“No”), the merchant server may disregard the received report transmission and the merchant server may continue receiving product search report messages by returning to block 232. Alternatively, if the consumer is not located in a merchant's store at the time a search is completed, the merchant server may save the information in a queue of counteroffers to be presented to particular consumers when they do enter a merchant's store.

In another embodiment, if the merchant server determines that the consumer's mobile computing device was not within a merchant store, but instead is close to the store, such as in the parking lot, the merchant server may determine that counteroffers may still be enacted. For example, if the merchant server determines that the mobile computing device is located in a merchant store's parking lot at the time of the Internet search, the merchant server may send counteroffer instructions that direct sales agents of the store to go out to the parking lot and address the consumer.

If the merchant server determines the consumer is located within a store (i.e., determination block 505=“Yes”), in determination block 510, the merchant server may evaluate the inventory of the store in which the consumer is located for the searched product identified in the product search report message. The merchant server may determine whether the searched product is currently in the store's inventory by accessing a database that contains inventory information for the merchant's stores. Alternatively, the merchant server may check the available inventory of the store by exchanging requests with computing devices at the store.

If the merchant store in which the consumer is located does not have the product (i.e., determination block 510=“No”), the merchant server may evaluate the store's inventory for similar products in determination block 515. For example, if the consumer searched for a particular TV model, the merchant server may determine whether the store's inventory includes a competitor product to that model. Also, the merchant server may determine whether a shipment of the particular product may arrive at the store in the future, in which case, the merchant server may propose a “rain check” or advance purchase counteroffer. In this manner, the store may offer the consumer a bonus product, discount, or other incentive for the consumer to commit to an in-store purchase without receiving the product immediately.

Further, if the particular product is not within the inventory of the store in which the consumer is located (i.e., determination block 510=“No”), as part of determination block 515, the merchant server may query the inventories of nearby merchant stores. If the searched-for product is present at one of these nearby stores, the merchant server may continue to evaluate whether a counteroffer is warranted. For example, the merchant server may factor-in additional overhead costs of shipping the product from a nearby store or the discounts that may be offered to the consumer for purchasing the product at the nearby merchant store.

In blocks 520-530, if the store in which the consumer is located has the searched-for product or an alternative that the merchant may offer during a counteroffer (i.e., determination block 510=“Yes” or determination block 515=“Yes”), the merchant may evaluate various factors to determine the parameters of any possible counteroffer to be offered to the consumer.

In block 520, the merchant server may evaluate previous merchant sales information, supply and demand data (or metrics), and the merchant's financial status to determine the merchant's ability to supply a counteroffer for the searched-for product. The merchant may interpret recent product sales to discern trends which may predict the merchant's success of future sales of the product. For example, the merchant server may determine that sales for the searched-for product have decreased precipitously every week for many weeks and thus a strong counteroffer may not be warranted. Alternatively, the merchant server may evaluate a lack of demand in the searched-for product as support for a strong counteroffer if the merchant has a large inventory of the product. For example, if the merchant store's inventory for a product exceeds a threshold inventory level, the merchant server may determine a strong counteroffer is warranted.

The merchant server may also assess the sales figures for the store over a financial period. For example, the merchant server may determine whether the store has met a sales quota and may determine to present a counteroffer if a sale would contribute to reaching the quota. In an embodiment, the merchant server may evaluate other financial variables in determining whether to present counteroffers.

The merchant server may evaluate sales information or statistical data regarding the product that may be used to define counteroffer parameters. The merchant server may determine the average, standard deviation, and other statistical metrics for sales of the searched-for product reported for a certain time period. The sales figures evaluated to determine the statistical information may be from the merchant's own and/or other merchants' sales records. For example, the merchant server may access sales information about the product from an industry resource that reports sales figures across all individual merchants. Further, the merchant server may ascertain the sales history of the searched-product in the particular store in which the consumer is located. For example, the merchant server may access statistics on the number units of the product that are typically sold in the store for a given time period.

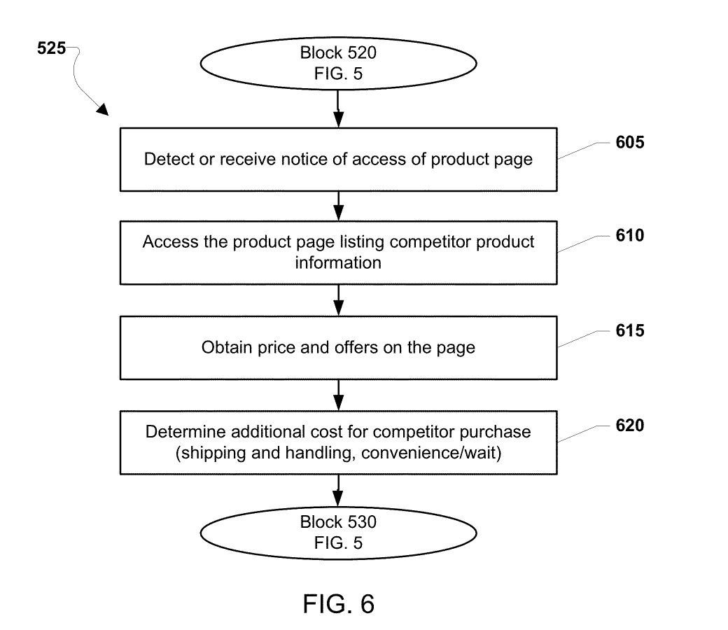

In block 525, the merchant server may determine the competition's pricing information for the product based on the intercepted consumer product search. In other words, the merchant server may determine the pricing “to beat” for the searched-for product. A description of an embodiment method for this evaluation is provided below with reference to FIG. 6.

In block 530, the merchant server may evaluate the consumer's personal information, such as prior shopping behaviors to gauge the receptiveness of the consumer to merchant counteroffers. This evaluation may also help the merchant server define the parameters for successful counteroffer actions for this particular consumer. In other words, the merchant server may determine how likely the consumer may be to accept a competing offer by the store if it is presented on a display, by a sales agent, or announced over the speaker system. The merchant server may query a sales history database to discover previous purchases by the consumer. For example, the database may contain information describing numerous purchases from the merchant by the consumer in the last year. The merchant server may also evaluate the customer based on loyalty policies enacted by the merchant. For example, the merchant may employ a frequent-purchaser program or any other program which attributes goodwill assessments of the consumer based on previous purchases with the merchant. In doing so, the merchant server may determine whether the consumer has any “bonus points” or other loyalty rewards that can be applied to purchasing the searched product and that may be included in a counteroffer.

In an embodiment, the merchant server may assess previous purchase habits by the consumer and extrapolate a likelihood of the consumer spending a certain amount. For example, based on purchases by the consumer in the last year, the merchant server may determine a high likelihood that the consumer may purchase again within a certain time period. In an embodiment, the merchant server may evaluate the consumer's spending history based on the value of the items purchased. For example, the merchant server may evaluate the consumer's previous purchases of items that were of a similar value as the searched-for product. In another embodiment, the merchant server may also compare the searched-for product to previous purchases based on product type/category/use. In another embodiment, the merchant server may maintain a counter describing the number of searches the consumer conducted for the particular product or type of product that have been intercepted by the merchant. For example, the merchant server may record that the consumer has conducted numerous searches with a multitude of competitors for the product within the last week.

As part of block 530, the merchant server may also evaluate the consumer's prior history using merchant credit accounts (i.e., store credit cards). For example, the merchant server may compare the searched-for product to prior purchases using the store credit card and project the likelihood that the consumer may use the credit account for the searched-for product. The merchant server may also evaluate the consumer's previous frequency of use of the merchant credit account. In another embodiment, the merchant server may estimate the value of a counteroffer in view of the consumer's history of paying balances on the store credit card.

In determination block 535, the merchant server may use the assessments and information developed in the operations in blocks 520-530 to determine whether the merchant should compete with a counteroffer presented to the consumer for the searched product. In an embodiment, the merchant server may assign values to the various assessments in blocks 520-530 and proceed with a counteroffer if a combined total value exceeds a threshold. For example, the merchant server may score various evaluations and, based on the sum of all the scores, if the sum exceeds a minimum value, the merchant server may offer a counteroffer to the consumer.

In another embodiment, the merchant server may utilize a rule-based decision procedure in determination block 535. For example, the merchant server may determine that a competing counteroffer is warranted based upon if the merchant possesses a surplus inventory of the searched product. As another example, the merchant server may determine that a counteroffer is not warranted if the store has a surplus of the product, but the recent national retail figures show a trend of increased sales and decreased supply. The assessment in blocks 520-530 may culminate in the assignment of values for variables in an equation that calculates the merchant's ability to offer a counteroffer and still make a profit as part of determination block 535. Alternatively, the merchant server may employ a table of threshold values predetermined by the merchant that define how the merchant server should decide given particular evaluations. For example, the merchant server may not consider a counteroffer that involves the merchant selling a product for more than a certain loss per unit.

In an embodiment, the merchant server may evaluate the assessments described in blocks 520-530 as equal considerations. For example, if the merchant server determines that the consumer's previous interactions with the store suggest that a positive response to a counteroffer is likely, the merchant server may proceed with a competitive counteroffer even if the determined competitor pricing is below the merchant's cost. In an alternative embodiment, the merchant server may weigh one consideration more heavily than the others. For example, if the merchant is attempting to increase goodwill with the shopping community or pre-existing customers, the merchant server may promote a counteroffer to a pre-existing consumer, even if the competitor's pricing is significantly lower than the merchant's threshold floor sales pricing. As another example, the merchant server may always offer a counteroffer when it intercepts product search information pertaining to particular competing parties or competing prices within a certain value range from the merchant's typical cost per unit of the searched product.

If the merchant server determines that a counteroffer is not warranted given the various assessments in blocks 520-530 (i.e., determination block 535=“No”), the merchant server may continue receiving product search report messages by returning to block 232.

If the merchant server determines that the merchant may compete by presenting a counteroffer to the consumer (i.e., determination block 535=“Yes”), the merchant server may generate and transmit counteroffer instructions to computing devices within the store. An example embodiment for generating counteroffer instructions is described below with reference to FIG. 7.

In an embodiment, the method 500 may be executed by computing devices within an individual merchant store and may include considerations of a particular store and/or region. For example, a store may be a franchise that may consider much different counteroffer parameters than other stores affiliated with the merchant. In an embodiment, the merchant may enable computing devices within individual stores to override, modify, and/or disregard counteroffer evaluations by the merchant server. For example, the manager of the store may investigate and countermand a decision by the merchant server that the merchant will not compete with a product search conducted by a consumer in the store.

FIG. 6 illustrates an embodiment method 525 for determining the competing price for a searched-for product by a competitor. In an embodiment, the method 600 may estimate a cost to the consumer for the search product if purchased through the competitor. In block 605, a merchant server may receive some information regarding an intercepted product search's competition, such as the competing party and product-identifying information. For example, a third-party service, as described above with reference to FIG. 3, may report base information to the merchant server, such as the competitor's business name and the product description. As another example, the merchant server may retrieve a URL which describes the domain name of the search website, the competitor identity, and possibly product search parameters on the competitor's website (e.g., product type, price, range, etc.). The received information may be obtained from browser history, cache data, intercepted packet data, etc.

In block 610, based on the received product information, the merchant server may replicate the consumer's search given the provided search information. For example, the merchant server may use Internet protocols to access the competitor's website and enter in search parameters comparable to the consumer's. In block 615, the merchant server may retrieve information from the competitor's web merchant server that describes the product offered, the number of units available, the price, and other details of the searched-for product. In an embodiment, the merchant server may determine available product options available through the competitor, such as colors, sizes, and styles. In block 615, the merchant server may proceed to acquire pricing data from the competitor's web information, such as base price and promotions/discounts. In an embodiment, the merchant server may procure any pricing differences between variances in product models/sizes/colors, etc. For example, the merchant server may determine that the competitor offers multiple colors of the product, each color offered at a different price.

In block 620, the merchant server may quantify other aspects associated with a purchase from the investigated competitor's website, such as shipping and handling costs and taxes. In an embodiment, the merchant server may imitate the inputs of a consumer by placing a product in the shopping cart of a competitor website session, entering values required to proceed to check-out, and recording final tabulated costs to purchase the product from the competitor's website. In an embodiment, the merchant server may estimate a convenience cost associated with shipping times, and increase the cost of purchasing the competitor's product online based on inconvenience to the consumer. For example, the merchant server may query the competitor's site for estimated times required for shipping the product to the consumer and determine an online purchase more inconvenient to the consumer due to a long wait until receipt of the goods.

In an embodiment, an intercepted search for a product by a consumer may include information from multiple competitors. For example, the consumer may request shopping data from an aggregator website which may return a list of numerous competitors and their associated information regarding the search product. In such cases, the merchant server may conduct the operations in blocks 605-620 for each competitor.

In another embodiment, the merchant server may query the competitor websites for information pertaining to other products than the product searched by the consumer. For example, in addition to discerning the competitor's pricing information for the searched-for product, the merchant server may conduct several other queries on the competitor website to gather the competitor's pricing information for similar products. As another example, the merchant server may procure competitor information regarding related goods to the searched-for product, such as accessories.

In an embodiment, the merchant server may maintain a database of known competitors and their estimated pricing schemes. For example, the merchant server may periodically determine and record a competitor's shipping rates borne by the consumer, shipping terms, and schedules. Alternatively, the merchant server may maintain a current record of known competitors' promotions. For example, the merchant server may record the coupons offered by a competitor for a particular product. The merchant server may also periodically query online coupon websites to discover and record active promotions for various competitors. Further, the merchant server may query consumer review sites for shopping community ratings for given competitors and record current ratings. The merchant server may use consumer review ratings to modify other assessments of a competitor's price (e.g., a good consumer review rating may increase the value for dollar of purchasing a product from the competitor and vice versa).

FIG. 7 illustrates an embodiment method 700 for creating counteroffer instructions in response to an intercepted Internet product search. The merchant server may create instructions to facilitate a counteroffer based on a determination that the store should compete with the intercepted Internet product search (i.e., determination block 235=“Yes”). In another embodiment, the instructions may be created by a computing device within the store (e.g., store computing device 160).

In optional block 710, the merchant server may discern a travel path of the consumer within the store. In an embodiment, the merchant server may record consumer location data received in report transmissions over a period of time. The merchant server may analyze the location data as a sequence over time and evaluate the consumer's movement to detect any travel patterns or paths. For example, based on the location data received, the merchant server may recognize that during the last few minutes the consumer has walked around the perimeter of the store in a certain direction. In another example, the merchant server may recognize that the consumer has moved between a set of departments over a period of time. The merchant server may use tracked movement data to predict where the consumer may travel within the store in the near future. The merchant server may employ dead reckoning calculations to estimate the location of the consumer at a certain point in the future. For example, based on the direction of travel and the change in locations throughout the store for a period of time, the merchant server may estimate that the consumer will be located near a particular store department.

In block 715, the merchant server may identify the store assets (or store display assets) that may best be able to present a counteroffer to the consumer given his/her location and movements. This may involve the merchant server identifying the store displays and/or sales agents that are best positioned to present the counteroffers based on their proximity to the consumer at the time of the intercepted Internet product search. The merchant server may compare the location information of the consumer against locations of the store assets to find appropriate recipient devices for receiving counteroffer instructions. The merchant server may have a data table which describes the location of the various store devices (e.g., advertising displays, tablet devices carried by sales agents, laptop devices stationed within store departments, etc.). In an embodiment, the various store devices may periodically transmit location information to the merchant server. For example, a store tablet device carried by a sales agent may transmit its location within the store every several minutes.

The merchant server may select the sales agents who should receive instructions by accessing an assignment document correlating sales agents to assigned departments. The merchant server may consider those sales agents who are actually in the store (i.e., on shift and not out sick) at the time of the intercepted Internet product search. If there are no nearby store displays or sales agents, the merchant server may determine that all store assets should receive the counteroffer instructions. The merchant server may also determine whether a counteroffer be announced via the loud speakers.

In an embodiment, the merchant server may identify all store displays and/or sales agents along a path predicted using operations in block 710. For example, the merchant server may recognize that the consumer is walking down a line of televisions that may display promotional advertising information.

In block 720, the merchant server may create counteroffer instructions to deliver to the store for execution by store assets. The counteroffer instructions may be for execution by computing devices or displays, commanding them to perform certain routines. For example, the merchant server may create instructions that are commands for store computing devices to display a slide presentation, play a video file, or emit particular sounds using attached speaker units. As another example, the merchant server may instruct the computing device to change the temperature of the store, dim the lights, or adjust/remove/switch the music played on the loud speakers. The merchant server may also create explicit directions for sales agents to act in a particular way. For example, the merchant server may create directions for the sales agents to approach the consumer and say certain things (e.g., competing offers of discounts, recommendations on product selection, give alternative options, etc.). As another example, the merchant server may send messages to the sales agents informing them of the consumer's product search. As another example, the merchant server may send sales agents counteroffer instructions which describe possible negotiation parameters. For example, the counteroffer instructions to a sales agent may state that the agent should approach the consumer and may negotiate a lower price within a certain discretionary price range.

The counteroffer instructions may include information about the merchant's competing offers to an intercepted Internet product search. As mentioned above, if the merchant server determines it will compete with the Internet search information, the merchant server may compose a competing offer that may include a discounted price for the searched-for product, a rebate offer, or other incentive promotions (e.g., two-for-one, additional unrelated products and/or accessories, etc.). The competing offer may involve attractive prices on products that are similar but not the searched-for product. For example, the intercepted search may regard a certain brand television, and the merchant server may create a competing offer for a similar television of a different brand. The competing offer may include store credit card promotions. The merchant server may include competing offers for other items the consumer may want to purchase. For example, the report transmission may indicate that the consumer had other items in an online shopping cart/list for which the merchant server may provide competing offers as well.

As part of block 720, the merchant server may develop competing offer language to present to the consumer. The merchant server may determine the parameters of a competing offer, such as the product, price, and any other incentive details, and may generate text to include these parameters. For example, the merchant server may generate a string of advertising language that conveys the competing offer to a consumer. In an embodiment, the merchant server may compose the language of a competing offer by using phrases stored in a database and related to the parameters of the competing offer. For example, the merchant server may generate informative advertising regarding the competing offer based on pre-existing advertising stored in the database with inserted information indicating the parameters of the competing offer. The merchant server may use a natural language processing routine to generate language to convey the parameters of the competing offer.

Also as part of block 725, the merchant server may adjust the counteroffer instructions based on the location of the consumer within the store. For example, the merchant server may discern that the consumer is located near a bank of television sets and may create a counteroffer that plays an ad on the television sets. As another example, the merchant server may send counteroffer instructions to the sales agent in one particular department as the consumer is located closer to one department than any other department.

Also as part of block 725, the merchant server may also factor in the path of the consumer through the store as it creates the counteroffer instructions. For example, based on recent reported consumer locations and estimated direction of travel, the merchant server may interpret the consumer's path as leading to the exit of the store, and thus may send instructions for a display near the exit door to play an advertisement relevant to the consumer's searched-for product. If the merchant server estimates that the consumer is leaving the store after previous counteroffers, the merchant server may generate new counteroffer instructions with more attractive competing offer parameters. For example, the merchant server may direct a second, higher discount for a product to be flashed on the displays above the exit doors.

Also as part of block 725, the merchant server may use the determined path of the consumer to supplement promotional offers. For example, the merchant server may interpret the consumer's path to be from one department to a related department. The merchant server may pair the intercepted Internet search product with the items sold in the estimated destination of the consumer and may create an offer including both products. For example, the merchant server may estimate that the consumer is walking from televisions to media (e.g., DVDs) and may create a promotional offer that involves both televisions and DVDs.

Also as part of block 725, the merchant server may use information about many consumers to create counteroffer instructions. The merchant server may use information provided from the store computing device regarding current store WiFi use as well as other intercepted Internet product search reports to determine whether other shoppers are located near the consumer. The merchant server may analyze the number of people shopping in the same area, information from their intercepted Internet product searches, and determine whether the counteroffer should include information applicable to the group of shoppers. For example, instead of tailoring a counteroffer promotion to the individual consumer, the merchant server may create a counteroffer promotion that involves all shoppers interested in a particular line of products. The merchant server may construct a promotion counteroffer that incentivizes multiple shoppers to purchase similar items within a close timeframe. For example, the merchant server may create a promotion which states that if a certain number of shoppers purchase the product (or one similar) searched for by the consumer, all purchases may be discounted or eligible for a rebate.

Also as part of block 725, personnel at the store may compose store-specific promotional information and/or augment counteroffer instructions sent from the merchant server. For example, the merchant server may send counteroffer instructions that direct a sales agent to offer the consumer a product that is no longer available in the store. In such a case, another sales agent may use a store computing device to exchange the counteroffer item with a currently available alternative product.

In block 725, the merchant server may transmit the counteroffer instructions to the store assets selected to present the counteroffer in block 715. The merchant server may transmit counteroffer instructions to computing devices in the store (e.g., sales agents' store tablet devices) directly or indirectly through a store computing device (e.g., the store computing device 160 in FIG. 1).

In block 730, the merchant server may record the details of the counteroffer in a database. The merchant server may use a relational database to record the time/date, consumer identification information, searched-for product data, and details of the counteroffer. Alternatively, the merchant server may also use a key or unique code to identify the counteroffer in the database and/or in the store. For example, the merchant server may assign a counteroffer promotional discount a code that the consumer must present to the sales clerk at the time of purchase. The merchant server may relay the counteroffer information, including the unique identifying information, to the store's computing device for use in subsequent transactions. For example, the merchant server may send a promotional code to the store's computing device which in turn sends it to a cash register computing device used to process the consumer's transaction.

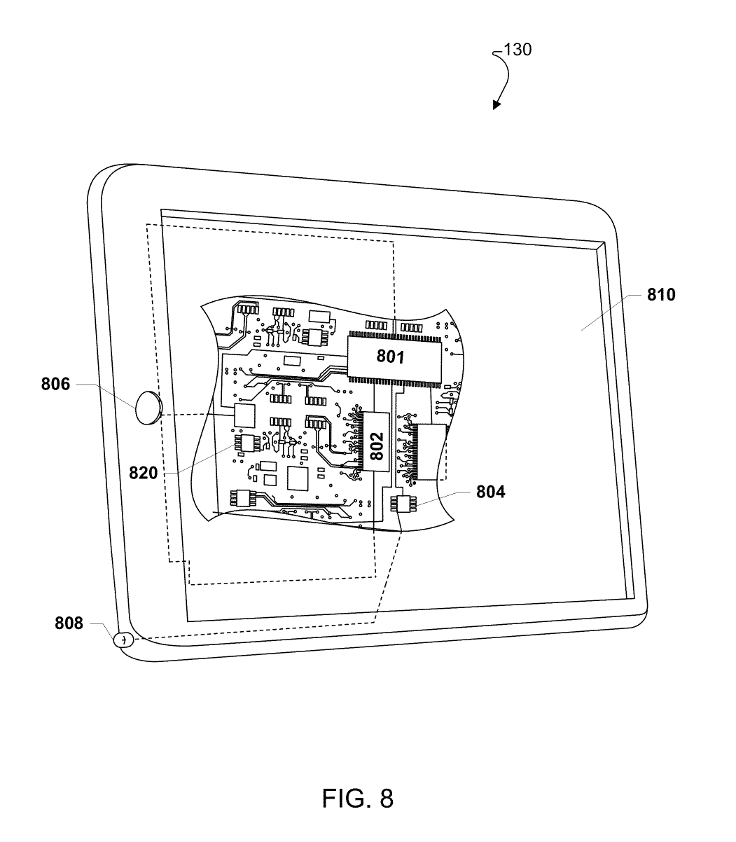

The various embodiments may be implemented in any of a variety of tablet devices, an example of which is illustrated in FIG. 8. For example, the tablet device 130 may include a processor 801 coupled to internal memory 802. The internal memory 802 may be volatile or non-volatile memory, and may also be secure and/or encrypted memory, or unsecure and/or unencrypted memory, or any combination thereof. The processor 801 may also be coupled to a touch screen display 810, such as a resistive-sensing touch screen, capacitive-sensing touch screen infrared sensing touch screen, or the like. The tablet device 130 may have one or more short-range radio signal transceivers 804 (e.g., Peanut, Bluetooth®, Zigbee®, RF radio) and antennas 808 for sending and receiving wireless signals as described herein. The transceivers 804 and antennas 808 may be used with the above-mentioned circuitry to implement the various wireless transmission protocol stacks/interfaces. The tablet device 130 may include a cellular network wireless modem chip 820 that enables communication via a cellular network. The tablet device 130 may also include a physical button 806 for receiving user inputs.

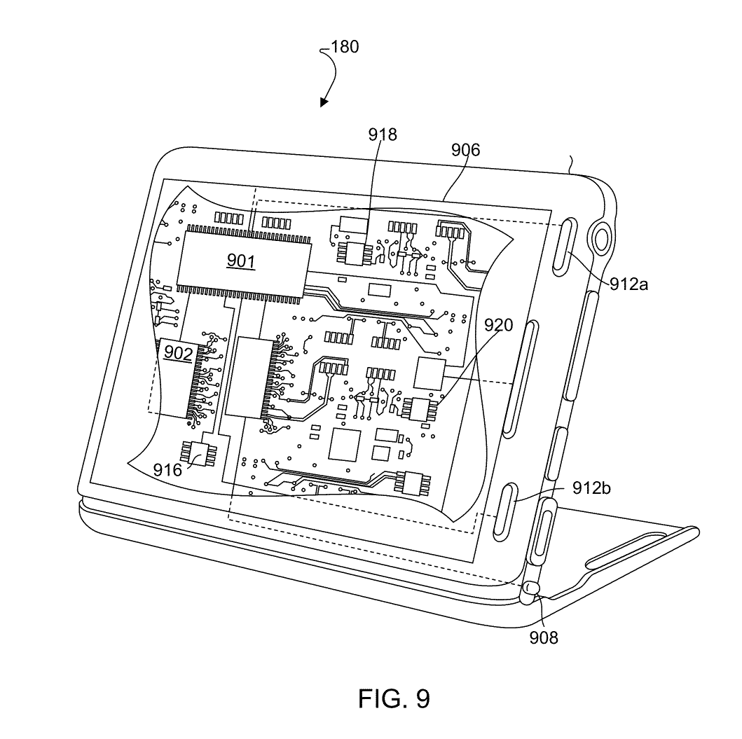

The various embodiments may be implemented in any of a variety of mobile computing devices (e.g., smartphones, feature phones, etc.), an example of which is illustrated in FIG. 9. For example, the mobile computing device 180 may include a processor 901 coupled to internal memory 902. The internal memory 902 may be volatile or non-volatile memory, and may also be secure and/or encrypted memory, or unsecure and/or unencrypted memory, or any combination thereof. The processor 901 may also be coupled to a touch screen display 906, such as a resistive-sensing touch screen, capacitive-sensing touch screen infrared sensing touch screen, or the like. Additionally, the display of the mobile computing device 180 need not have touch screen capability. The mobile computing device 180 may have one or more short-range radio signal transceivers 918 (e.g., Peanut, Bluetooth®, Zigbee®, RF radio) and antennas 908 for sending and receiving wireless signals as described herein. The transceivers 918 and antennas 908 may be used with the above-mentioned circuitry to implement the various wireless transmission protocol stacks/interfaces. The mobile computing device 180 may include a cellular network wireless modem chip 920 that enables communication via a cellular network. The mobile computing device 180 may also include physical buttons 912a and 912b for receiving user inputs.

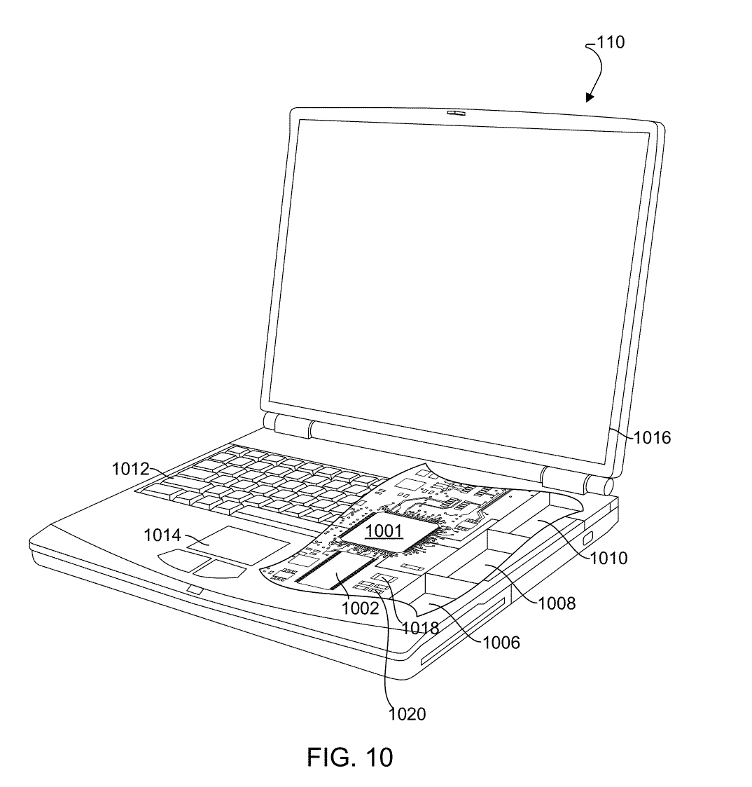

Other forms of computing devices, including personal computers and laptop computers, may be used to implementing the various embodiments. Such computing devices typically include the components illustrated in FIG. 10 which illustrates an example laptop computer device 110. Many laptop computers include a touch pad touch surface 1014 that serves as the computer's pointing device, and thus may receive drag, scroll, and flick gestures similar to those implemented on mobile computing devices equipped with a touch screen display and described above. Such a laptop computer 110 generally includes a processor 1001 coupled to volatile internal memory 1002 and a large capacity nonvolatile memory, such as a disk drive 1006. The laptop computer 110 may also include a compact disc (CD) and/or DVD drive 1008 coupled to the processor 1001. The laptop computer device 110 may also include a number of connector ports 1010 coupled to the processor 1001 for establishing data connections or receiving external memory devices, such as a network connection circuit for coupling the processor 1001 to a network. The laptop computer device 110 may have one or more short-range radio signal transceivers 1018 (e.g., Peanut, Bluetooth®, Zigbee®, RF radio) and antennas 1020 for sending and receiving wireless signals as described herein. The transceivers 1018 and antennas 1020 may be used with the above-mentioned circuitry to implement the various wireless transmission protocol stacks/interfaces. In a laptop or notebook configuration, the computer housing includes the touch pad 1014, the keyboard 1012, and the display 1016 all coupled to the processor 1001. Other configurations of the computing device may include a computer mouse or trackball coupled to the processor (e.g., via a USB input) as are well known, which may also be used in conjunction with the various embodiments.

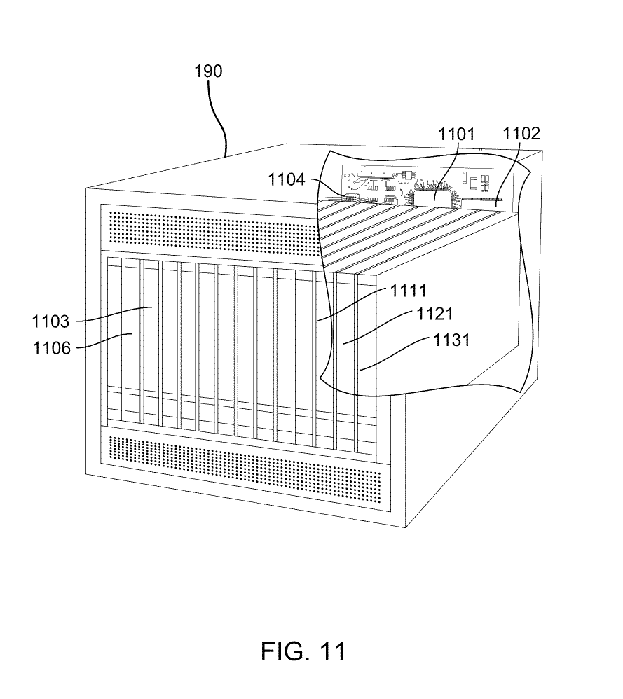

The various embodiments may also be implemented on any of a variety of commercially available server devices, such as the merchant server 190 illustrated in FIG. 11. Such a server 190 typically includes a processor 1101, and may include multiple processor systems 1111, 1121, 1131, one or more of which may be or include multi-core processors. The processor 1101 may be coupled to volatile internal memory 1102 and a large capacity nonvolatile memory, such as a disk drive 1103. The merchant server 190 may also include a floppy disc drive, compact disc (CD) or DVD disc drive 1104 coupled to the processor 1101. The server 190 may also include network access ports 1106 coupled to the processor 1101 for establishing network interface connections with a network 1107, such as a local area network coupled to other broadcast system computers and servers.

The processors 801, 901, 1001, 1101, 1111, 1121, and 1131 may be any programmable microprocessor, microcomputer or multiple processor chip or chips that can be configured by software instructions (applications) to perform a variety of functions, including the functions of the various embodiments described above. In some wireless sensor devices, multiple processors may be provided, such as one processor dedicated to wireless communication functions and one processor dedicated to running other applications. Typically, software applications may be stored in the internal memory 802, 902, 1002, and 1102 before they are accessed and loaded into the processors 801, 901, 1001, 1101, 1111, 1121, and 1131. The processors 801, 901, 1001, 1101, 1111, 1121, and 1131 may include internal memory sufficient to store the application software instructions. In many devices the internal memory may be a volatile or nonvolatile memory, such as flash memory, or a mixture of both. For the purposes of this description, a general reference to memory refers to memory accessible by the processors 801, 901, 1001, 1101, 1111, 1121, and 1131 including internal memory or removable memory plugged into the wireless sensor device and memory within the processors 801, 901, 1001, 1101, 1111, 1121, and 1131.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a tangible, non-transitory computer-readable or server-readable storage medium. Tangible, non-transitory computer-readable or server-readable storage media may be any available media that may be accessed by a computer. By way of example, and not limitation, such non-transitory computer-readable or server-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable or server-readable media. Additionally, the operations of a method or algorithm may reside as one or any combination or set of codes and/or instructions on a tangible, non-transitory machine readable, server-readable and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for enabling a merchant to compete with online retailers for a sale of a product using counteroffers within a merchant store, comprising:
detecting an Internet product search conducted on a consumer's mobile computing device for a product;
determining whether the consumer's mobile computing device is located within a merchant's store;
determining in a server whether to present a counteroffer to the consumer based at least in part on the detected Internet product search in response to determining that the consumer's mobile computing device is located within a merchant's store;
generating instructions for presenting a counteroffer to the consumer within the merchant's store in response to determining that a counteroffer should be presented to the consumer; and
transmitting the generated instructions to at least one store display asset for presenting the counteroffer to the consumer.

2. The method of claim 1, wherein detecting an Internet product search conducted on a consumer's computing device comprises:
distributing a software application for use on the consumer's mobile computing device;
detecting the Internet product search with routines executed as background processes on a processor of the consumer's mobile computing device, and
sending a product search report message to the server providing information about the detected Internet product search.

3. The method of claim 1, wherein detecting an Internet product search conducted on a consumer's mobile computing device comprises:
providing Internet access to the consumer via a local area network within the merchant's store;
detecting the Internet product search with a store computing device that monitors data exchanges between consumer mobile computing devices and the Internet, and
sending a product search report message to the server providing information about the detected Internet product search.

4. The method of claim 1, wherein detecting an Internet product search conducted on a consumer's mobile computing device comprises:
receiving a product search report message in the server from a third-party server providing information about an Internet product search conducted by the consumer through the third-party server.

5. The method of claim 1, wherein transmitting the generated instructions to at least one store display asset for presenting the counteroffer to the consumer comprises instructions for the at least one store display asset to perform one or more of displaying a counteroffer on a store display, making an in-store audible announcement of a counteroffer, and providing a sales agent's computing device with the counteroffer and a location of the consumer within the merchant's store.

6. The method of claim 1, wherein the counteroffer includes at least one of a reduced price for the product, discounts on other products, a rebate, free products, future discounts, store credit account incentives, and consumer loyalty incentives.

7. The method of claim 1, wherein determining in a server whether to present a counteroffer to the consumer comprises determining whether to present a counteroffer to the consumer based on whether current in-store inventory level for the product is above a threshold inventory level defined for the product.

8. The method of claim 1, wherein determining in a server whether to present a counteroffer to the consumer comprises:
evaluating with the server supply and demand metrics relating to the product; and
comparing merchant store inventory to the evaluated supply and demand metrics.

9. The method of claim 1, wherein determining in a server whether to present a counteroffer to the consumer comprises:
assessing at least one of the merchant's sales information, the merchant store's inventory, and characteristics of the product;
estimating a cost to the consumer of purchasing the product through a competitor; and
evaluating the consumer's previous transactions with the merchant.

10. The method of claim 9, wherein estimating the cost to the consumer of purchasing the product through a competitor comprises:
identifying Internet competitors based on the detected Internet product search;
accessing with the server webpages accessed in the detected Internet product search;
obtaining the Internet competitors' pricing information from the accessed webpages; and
determining ancillary costs of the consumer purchasing the product via the Internet competitors.

11. The method of claim 1, wherein generating instructions for presenting a counteroffer to the consumer within the merchant's store comprises:
identifying store display assets best positioned to present the counteroffer to the consumer; and
generating instructions for the identified store display assets to present the counteroffer to the consumer.

12. The method of claim 11, wherein identifying store display assets best positioned to present the counteroffer to the consumer comprises:
predicting the consumer's path within the merchant store; and
comparing the path to locations of store display assets.

13. A server, comprising:
a memory; and
a server processor coupled to the memory and configured with processor-executable instructions to perform operations comprising:
determining whether a mobile computing device of a consumer is located within a merchant's store;
determining whether to present a counteroffer to the consumer based at least in part on a detected Internet product search in response to determining that the consumer's mobile computing device is located within a merchant's store;
generating instructions for presenting a counteroffer to the consumer within the merchant's store in response to determining that a counteroffer should be presented to the consumer; and
transmitting the generated instructions to at least one store display asset for presenting the counteroffer to the consumer.

14. The server of claim 13, wherein the server processor is configured with processor-executable instructions to perform operations further comprising receiving a product search report message from a third-party server providing information about the Internet product search conducted by the consumer through the third-party server.

15. The server of claim 13, wherein the server processor is configured with processor-executable instructions to perform operations such that transmitting the generated instructions to at least one store display asset for presenting the counteroffer to the consumer comprises instructions for the at least one store display asset to perform one or more of displaying a counteroffer on a store display, making an in-store audible announcement of a counteroffer, and providing a sales agent's computing device with the counteroffer and a location of the consumer within the merchant's store.

16. The server of claim 13, wherein the server processor is configured with processor-executable instructions to perform operations such that the counteroffer includes at least one of a reduced price for the product, discounts on other products, a rebate, free products, future discounts, store credit account incentives, and consumer loyalty incentives.

17. The server of claim 13, wherein the server processor is configured with processor-executable instructions to perform operations such that determining whether to present a counteroffer to the consumer comprises determining whether to present a counteroffer to the consumer based on whether current in-store inventory level for the product is above a threshold inventory level defined for the product.

18. The server of claim 13, wherein the server processor is configured with processor-executable instructions to perform operations such that determining whether to present a counteroffer to the consumer comprises:
evaluating supply and demand metrics relating to the product; and
comparing merchant store inventory to the evaluated supply and demand metrics.

19. The server of claim 13, wherein the server processor is configured with processor-executable instructions to perform operations such that determining whether to present a counteroffer to the consumer comprises:
assessing at least one of the merchant's sales information, the merchant store's inventory, and characteristics of the product;
estimating a cost to the consumer of purchasing the product through a competitor; and
evaluating the consumer's previous transactions with the merchant.

20. The server of claim 19, wherein the server processor is configured with processor-executable instructions to perform operations such that estimating the cost to the consumer of purchasing the product through a competitor comprises:
identifying Internet competitors based on the detected Internet product search;
accessing webpages accessed by the consumer in the detected Internet product search;
obtaining the Internet competitors' pricing information from the accessed webpages; and
determining ancillary costs of the consumer purchasing the product via the Internet competitors.

21. The server of claim 13, wherein the server processor is configured with processor-executable instructions to perform operations such that generating instructions for presenting a counteroffer to the consumer within the merchant's store comprises:
identifying store display assets best positioned to present the counteroffer to the consumer; and
generating instructions for the identified store display assets to present the counteroffer to the consumer.

22. The server of claim 21, wherein the server processor is configured with processor-executable instructions to perform operations such that identifying store display assets best positioned to present the counteroffer to the consumer comprises:
predicting the consumer's path within the merchant store; and
comparing the path to locations of store display assets.

23. A server, comprising:
means for determining whether a mobile computing device of a consumer is located within a merchant's store;
means for determining whether to present a counteroffer to the consumer based at least in part on a detected Internet product search in response to determining that the consumer's mobile computing device is located within a merchant's store;
means for generating instructions for presenting a counteroffer to the consumer within the merchant's store in response to determining that a counteroffer should be presented to the consumer; and
means for transmitting the generated instructions to at least one store display asset for presenting the counteroffer to the consumer.

24. The server of claim 23, further comprising means for receiving a product search report message from a third-party server providing information about the Internet product search conducted by the consumer through the third-party server.

25. The server of claim 23, wherein means for transmitting the generated instructions to at least one store display asset for presenting the counteroffer to the consumer comprises instructions for the at least one store display asset to perform one or more of displaying a counteroffer on a store display, making an in-store audible announcement of a counteroffer, and providing a sales agent's computing device with the counteroffer and a location of the consumer within the merchant's store.

26. The server of claim 23, wherein the counteroffer includes at least one of a reduced price for the product, discounts on other products, a rebate, free products, future discounts, store credit account incentives, and consumer loyalty incentives.

27. The server of claim 23, wherein means for determining whether to present a counteroffer to the consumer comprises means for determining whether to present a counteroffer to the consumer based on whether current in-store inventory level for the product is above a threshold inventory level defined for the product.

28. The server of claim 23, wherein means for determining whether to present a counteroffer to the consumer comprises:
means for evaluating supply and demand metrics relating to the product; and
means for comparing merchant store inventory to the evaluated supply and demand metrics.

29. The server of claim 23, wherein means for determining whether to present a counteroffer to the consumer comprises:
means for assessing at least one of the merchant's sales information, the merchant store's inventory, and characteristics of the product;
means for estimating a cost to the consumer of purchasing the product through a competitor; and
means for evaluating the consumer's previous transactions with the merchant.

30. The server of claim 29, wherein means for estimating the cost to the consumer of purchasing the product through a competitor comprises:
means for identifying Internet competitors based on the detected Internet product search;
means for accessing webpages accessed by the consumer in the detected Internet product search;
means for obtaining the Internet competitors' pricing information from the accessed webpages; and
means for determining ancillary costs of the consumer purchasing the product via the Internet competitors.

31. The server of claim 23, wherein means for generating instructions for presenting a counteroffer to the consumer within the merchant's store comprises:
means for identifying store display assets best positioned to present the counteroffer to the consumer; and
means for generating instructions for the identified store display assets to present the counteroffer to the consumer.

32. The server of claim 31, wherein means for identifying store display assets best positioned to present the counteroffer to the consumer comprises:
means for predicting the consumer's path within the merchant store; and
means for comparing the path to locations of store display assets.

33. A non-transitory server-readable storage medium having stored thereon processor-executable instructions configured to cause a server processor to perform operations for enabling a merchant to compete with online retailers for a sale of a product using counteroffers within a merchant store, the operations comprising:
determining whether a mobile computing device of a consumer is located within a merchant's store;
determining whether to present a counteroffer to the consumer based at least in part on a detected Internet product search in response to determining that the consumer's mobile computing device is located within a merchant's store;
generating instructions for presenting a counteroffer to the consumer within the merchant's store in response to determining that a counteroffer should be presented to the consumer; and
transmitting the generated instructions to at least one store display asset for presenting the counteroffer to the consumer.

34. The non-transitory server-readable storage medium of claim 33, wherein the stored processor-executable software instructions are configured to cause a server processor to perform operations further comprising receiving a product search report message from a third-party server providing information about the Internet product search conducted by the consumer through the third-party server.

35. The non-transitory server-readable storage medium of claim 33, wherein the stored processor-executable software instructions are configured to cause a server processor to perform operations such that transmitting the generated instructions to at least one store display asset for presenting the counteroffer to the consumer comprises instructions for the at least one store display asset to perform one or more of displaying a counteroffer on a store display, making an in-store audible announcement of a counteroffer, and providing a sales agent's computing device with the counteroffer and a location of the consumer within the merchant's store.

36. The non-transitory server-readable storage medium of claim 33, wherein the stored processor-executable software instructions are configured to cause a server processor to perform operations such that the counteroffer includes at least one of a reduced price for the product, discounts on other products, a rebate, free products, future discounts, store credit account incentives, and consumer loyalty incentives.

37. The non-transitory server-readable storage medium of claim 33, wherein the stored processor-executable software instructions are configured to cause a server processor to perform operations such that determining whether to present a counteroffer to the consumer comprises determining whether to present a counteroffer to the consumer based on whether current in-store inventory level for the product is above a threshold inventory level defined for the product.

38. The non-transitory server-readable storage medium of claim 33, wherein the stored processor-executable software instructions are configured to cause a server processor to perform operations such that determining whether to present a counteroffer to the consumer comprises:
evaluating supply and demand metrics relating to the product; and
comparing merchant store inventory to the evaluated supply and demand metrics.

39. The non-transitory server-readable storage medium of claim 33, wherein the stored processor-executable software instructions are configured to cause a server processor to perform operations such that determining whether to present a counteroffer to the consumer comprises:
assessing at least one of the merchant's sales information, the merchant store's inventory, and characteristics of the product;
estimating a cost to the consumer of purchasing the product through a competitor; and
evaluating the consumer's previous transactions with the merchant.

40. The non-transitory server-readable storage medium of claim 39, wherein the stored processor-executable software instructions are configured to cause a server processor to perform operations such that estimating the cost to the consumer of purchasing the product through a competitor comprises:
identifying Internet competitors based on the detected Internet product search;
accessing webpages accessed by the consumer in the detected Internet product search;
obtaining the Internet competitors' pricing information from the accessed webpages; and
determining ancillary costs of the consumer purchasing the product via the Internet competitors.

41. The non-transitory server-readable storage medium of claim 33, wherein the stored processor-executable software instructions are configured to cause a server processor to perform operations such that generating instructions for presenting a counteroffer to the consumer within the merchant's store comprises:
identifying store display assets best positioned to present the counteroffer to the consumer; and
generating instructions for the identified store display assets to present the counteroffer to the consumer.

42. The non-transitory server-readable storage medium of claim 41, wherein the stored processor-executable software instructions are configured to cause a server processor to perform operations such that identifying store display assets best positioned to present the counteroffer to the consumer comprises:
predicting the consumer's path within the merchant store; and
comparing the path to locations of store display assets.

43. A system, comprising:
a server; and
a plurality of store display assets,
wherein the server comprises:
a memory; and
a server processor coupled to the memory and configured with processor-executable instructions to perform operations comprising:
determining whether a mobile computing device of a consumer is located within a merchant's store;
determining whether to present a counteroffer to the consumer based at least in part on a detected Internet product search in response to determining that the consumer's mobile computing device is located within a merchant's store;
generating instructions for presenting a counteroffer to the consumer within the merchant's store in response to determining that a counteroffer should be presented to the consumer; and
transmitting the generated instructions to at least one of the plurality of store display assets for presenting the counteroffer to the consumer, and
wherein each of the store display assets comprises:
a memory; and
a processor coupled to the memory and configured with processor-executable instructions to perform operations comprising:
receiving the generated instructions from the server; and
executing the received instructions to present the counteroffer to the consumer.

44. The system of claim 43, wherein the server processor is configured with processor-executable instructions to perform operations further comprising receiving a product search report message from a third-party server providing information about the Internet product search conducted by the consumer through the third-party server.

45. The system of claim 43, wherein the server processor is configured with processor-executable instructions to perform operations such that transmitting the generated instructions to at least one of the plurality of store display assets comprises instructions for the at least one of the plurality of store display assets to perform one or more of displaying a counteroffer on a store display, making an in-store audible announcement of a counteroffer, and providing a sales agent's computing device with the counteroffer and a location of the consumer within the merchant's store, and
wherein the processor is configured with processor-executable instructions to perform operations such that executing the received instructions for presenting the counteroffer to the consumer comprises at least one of displaying a counteroffer on a store display, making an in-store audible announcement of a counteroffer, and providing a sales agent's computing device with the counteroffer and a location of the consumer within the merchant's store.

46. The system of claim 43, wherein the server processor is configured with processor-executable instructions to perform operations such that the counteroffer includes at least one of a reduced price for the product, discounts on other products, a rebate, free products, future discounts, store credit account incentives, and consumer loyalty incentives.

47. The system of claim 43, wherein the server processor is configured with processor-executable instructions to perform operations such that determining whether to present a counteroffer to the consumer comprises determining whether to present a counteroffer to the consumer based on whether current in-store inventory level for the product is above a threshold inventory level defined for the product.

48. The system of claim 43, wherein the server processor is configured with processor-executable instructions to perform operations such that determining whether to present a counteroffer to the consumer comprises:
evaluating supply and demand metrics relating to the product; and
comparing merchant store inventory to the evaluated supply and demand metrics.

49. The system of claim 43, wherein the server processor is configured with processor-executable instructions to perform operations such that determining whether to present a counteroffer to the consumer comprises:
assessing at least one of the merchant's sales information, the merchant store's inventory, and characteristics of the product;
estimating a cost to the consumer of purchasing the product through a competitor; and
evaluating the consumer's previous transactions with the merchant.

50. The system of claim 49, wherein the server processor is configured with processor-executable instructions to perform operations such that estimating a cost to the consumer of purchasing the product through a competitor comprises:
identifying Internet competitors based on the detected Internet product search;
accessing webpages accessed by the consumer in the detected Internet product search;
obtaining the Internet competitors' pricing information from the accessed webpages; and
determining ancillary costs of the consumer purchasing the product via the Internet competitors.

51. The system of claim 43, wherein the server processor is configured with processor-executable instructions to perform operations such that generating instructions for presenting a counteroffer to the consumer within the merchant's store comprises:
identifying at least one of the plurality of store display assets best positioned to present the counteroffer to the consumer; and
generating instructions for the identified store display assets to present the counteroffer to the consumer.

52. The system of claim 51, wherein the server processor is configured with processor-executable instructions to perform operations such that identifying at least one of the plurality of store display assets best positioned to present the counteroffer to the consumer comprises:
predicting the consumer's path within the merchant's store; and
comparing the path to locations of store display assets.

53. The system of claim 43, further comprising:
a mobile computing device comprising:
a memory;
a transceiver configured to communicate using wireless transmissions; and
a processor coupled to the memory and the transceiver, wherein the processor is configured with processor-executable instructions to perform operations comprising:
executing a software application as background processes on the processor;
performing the Internet product search based on consumer input on the mobile computing device;
detecting the Internet product search with routines related to the executed software application; and
transmitting a product search report message to the server providing information about the detected Internet product search,
wherein the server processor is configured with processor-executable instructions to perform operations such that:
determining whether a mobile computing device of a consumer is located within a merchant's store comprises determining whether a mobile computing device of a consumer is located within a merchant's store comprises based on the transmitted product search report message; and
determining whether to present a counteroffer to the consumer based at least in part on a detected Internet product search in response to determining that the consumer's mobile computing device is located within a merchant's store comprises determining whether to present a counteroffer to the consumer based at least in part on the transmitted product search report message.

54. The system of claim 43, further comprising:
a store computing device comprising:
a memory; and
a processor coupled to the memory and configured with processor-executable instructions to perform operations comprising:
detecting the Internet product search by monitoring data exchanges between consumer mobile computing devices and the Internet via a local area network within the merchant's store, and
transmitting a product search report message to the server providing information about the detected Internet product search, and
wherein the server processor is configured with processor-executable instructions to perform operations such that:
determining whether a mobile computing device of a consumer is located within a merchant's store comprises determining whether a mobile computing device of a consumer is located within a merchant's store comprises based on the transmitted product search report message; and
determining whether to present a counteroffer to the consumer based at least in part on a detected Internet product search in response to determining that the consumer's mobile computing device is located within a merchant's store comprises determining whether to present a counteroffer to the consumer based at least in part on the transmitted product search report message.
